(19) United States
(12) Patent Application Publication
(10) Pub. No.: US 2026/0154054 A1
(43) Pub. Date: Jun. 4, 2026

(54) DPU infrastructure management

(71) Applicant: Mellanox Technologies, Ltd., Yokneam (IL)

(72) Inventors: Mael Kimmerlin, Bethune (FR); Gal Zaidman Ben Jacob, Tel Aviv (IL); Ron Yuval Efraim, Tzor Hadash (IL); Erez Cohen, Eilat (IL); Alexander Petrovskiy, Santa Clara, CA (US); Tzahi Oved, Ramat Gan (IL)

(21) Appl. No.: 19/378,399

(22) Filed: Nov. 4, 2025

Related U.S. Application Data
(60) Provisional application No. 63/727,677, filed on Dec. 4, 2024.

(51) Int. Cl. G06F 8/61; G06F 9/4401; G06F 9/455; G06F 9/48; G06F 9/50

(52) U.S. Cl. CPC G06F 8/61; G06F 9/4406; G06F 9/455; G06F 9/4881; G06F 9/5077; G06F 2209/505

(57) ABSTRACT

In one embodiment, a system includes a plurality of host computers, a plurality of data processing units (DPUs), each DPU including a network interface controller (NIC) and processing cores, each DPU being connected to a respective one of the host computers, and at least one management node to provision software on the processing cores of each DPU, and synchronize a lifecycle of each DPU with a lifecycle of the respective host computer during the provisioning of the software.

### RELATED APPLICATION INFORMATION

The present application claims benefit of U.S. Provisional Patent Application Ser. No. 63/727,677 of Kimmerlin, et al., filed 4 Dec. 2024, the disclosure of which is hereby incorporated herein by reference.

### FIELD OF THE DISCLOSURE

The present disclosure relates to data processing unit infrastructure management, and more particularly but not exclusively to provisioning and lifecycle management of data processing units in computing environments.

### BACKGROUND

Modern data centers and high-performance computing environments increasingly rely on specialized processing units to handle diverse computational workloads. These environments typically include various types of processing hardware, including central processing units (CPUs), graphics processing units (GPUs), and data processing units (DPUs), each optimized for different types of tasks. DPUs, in particular, have emerged as specialized hardware components designed to offload networking, storage, and security functions from host processors.

### OVERVIEW

There is provided in accordance with an embodiment of the present disclosure, a system, comprising a plurality of host computers, a plurality of data processing units (DPUs), each DPU comprising a network interface controller (NIC) and processing cores, each DPU being connected to a respective one of the host computers, and at least one management node to provision software on the processing cores of each DPU, and synchronize a lifecycle of each DPU with a lifecycle of the respective host computer during the provisioning of the software.

Further in accordance with an embodiment of the present disclosure, the software comprises an operating system.

Still further in accordance with an embodiment of the present disclosure, the at least one management node is to provision the operating system on the processing cores of each DPU via a management path through a host operating system of the respective host computer.

Additionally, in accordance with an embodiment of the present disclosure, the at least one management node is to provision the operating system on the processing cores of each DPU via an out-of-band management path through a baseboard management controller (BMC) of each DPU without relying on host operating system access.

Moreover, in accordance with an embodiment of the present disclosure, the software comprises any one or more of the following packet processing services, DPU management services, or security services.

Further in accordance with an embodiment of the present disclosure, the software comprises containerized applications.

Still further in accordance with an embodiment of the present disclosure, synchronizing the lifecycle of each DPU with the lifecycle of the respective host computer comprises applying node effects to the respective host computer during provisioning of the software on each DPU.

Additionally, in accordance with an embodiment of the present disclosure, the node effects comprise at least one of draining workloads from the respective host computer, preventing workloads from running on the respective host computer, creating an event for reaction by an application running on the respective host computer, or running a user-provided script on the respective host computer.

Moreover, in accordance with an embodiment of the present disclosure, synchronizing the lifecycle of each DPU with the lifecycle of the respective host computer comprises coordinating workload scheduling between each DPU and the respective host computer.

Further in accordance with an embodiment of the present disclosure, the at least one management node is to provision the software on the processing cores of each DPU using a two-tier container orchestration platform architecture comprising a host cluster and at least one DPU cluster, wherein the at least one DPU cluster is managed by the host cluster.

Still further in accordance with an embodiment of the present disclosure, the at least one management node is to automatically scale and create additional DPU clusters as a number of DPUs in the plurality of DPUs grows.

Additionally, in accordance with an embodiment of the present disclosure, the at least one management node is to use a container orchestration platform API for provisioning and orchestrating services on each DPU.

Moreover, in accordance with an embodiment of the present disclosure, the at least one management node is to define service function chaining between services installed on the processing cores of each DPU, and the processing cores of each DPU are to implement the defined service function chaining.

Further in accordance with an embodiment of the present disclosure, the at least one management node is to define the service function chaining based on user input via an API, the user input specifying service ordering within the chains, and configuration of network policies for traffic routing between services in the chains.

Still further in accordance with an embodiment of the present disclosure, the processing cores of one of the plurality of DPUs is to process a packet of a network flow using the chained services, analyze at least one result of the processing of the packet, and program packet processing pipeline hardware of the one DPU to process subsequent packets of the network flow according to the at least one analyzed result.

There is provided in accordance with another embodiment of the present disclosure, a management node system, comprising an interface to connect to a plurality of host computers and/or a plurality of data processing units (DPUs), each DPU being connected to a respective one of the plurality of host computers, each DPU comprising a network interface controller (NIC) and processing cores, and at least one processor to provision software on the processing cores of each DPU, and synchronize a lifecycle of each DPU with a lifecycle of the respective host computer during the provisioning of the software.

Additionally, in accordance with an embodiment of the present disclosure, the software comprises an operating system.

Moreover, in accordance with an embodiment of the present disclosure, the at least one processor is to provision the operating system on the processing cores of each DPU via a management path through a host operating system of the respective host computer.

Further in accordance with an embodiment of the present disclosure, the at least one processor is to provision the operating system on the processing cores of each DPU via an out-of-band management path through a baseboard management controller (BMC) of each DPU without relying on host operating system access.

Still further in accordance with an embodiment of the present disclosure, the software comprises any one or more of the following packet processing services, DPU management services, or security services.

Additionally, in accordance with an embodiment of the present disclosure, the software comprises containerized applications.

Moreover, in accordance with an embodiment of the present disclosure, synchronizing the lifecycle of each DPU with the lifecycle of the respective host computer comprises applying node effects to the respective host computer during provisioning of the software on each DPU.

Further in accordance with an embodiment of the present disclosure, the node effects comprise at least one of draining workloads from the respective host computer, preventing workloads from running on the respective host computer, creating an event for reaction by an application running on the respective host computer, or running a user-provided script on the respective host computer.

Still further in accordance with an embodiment of the present disclosure, synchronizing the lifecycle of each DPU with the lifecycle of the respective host computer comprises coordinating workload scheduling between each DPU and the respective host computer.

Additionally, in accordance with an embodiment of the present disclosure, the at least one processor is to provision the software on the processing cores of each DPU using a two-tier container orchestration platform architecture comprising a host cluster and at least one DPU cluster, wherein the at least one DPU cluster is managed by the host cluster.

Moreover, in accordance with an embodiment of the present disclosure, the at least one processor is to automatically scale and create additional DPU clusters as a number of DPUs in the plurality of DPUs grows.

Further in accordance with an embodiment of the present disclosure, the at least one processor is to use a container orchestration platform API for provisioning and orchestrating services on each DPU.

Still further in accordance with an embodiment of the present disclosure, the at least one processor is to define service function chaining between services installed on the processing cores of each DPU based on user input via an API, the user input specifying service ordering within the chains, and configuration of network policies for traffic routing between services in the chains.

There is also provided in accordance with still another embodiment of the present disclosure, a data processing unit (DPU), comprising a network interface controller (NIC) including packet processing pipeline hardware, and processing cores to run services, and implement a defined service function chaining between respective ones of the services.

Additionally, in accordance with an embodiment of the present disclosure, the processing cores are to process a packet of a network flow using the chained services, analyze at least one result of the processing of the packet, and program the packet processing pipeline hardware to process subsequent packets of the network flow according to the at least one analyzed result.

### BRIEF DESCRIPTION OF THE DRAWINGS

The present disclosure will be understood from the following detailed description, taken in conjunction with the drawings in which:

FIG. 1 is a partly pictorial, partly block diagram view of a system including management nodes, host computers, and data processing units, constructed and operative in accordance with an embodiment of the present disclosure;

FIG. 2 is a partly pictorial, partly block diagram view of the system of FIG. 1 with service deployment on the data processing units, constructed and operative in accordance with an embodiment of the present disclosure;

FIG. 3 is a flowchart including steps in a method for provisioning software on processing cores of the data processing units of FIG. 1;

FIG. 4 is a partly pictorial, partly block diagram view of the system of FIG. 1 implementing service function chaining, constructed and operative in accordance with an embodiment of the present disclosure;

FIG. 5 is a flowchart including steps in a method for running services and implementing service function chaining in the system of FIG. 4; and

FIG. 6 is a block diagram that schematically illustrates a computing system, e.g., a data center or a High-Performance Computing (HPC) cluster, in accordance with an embodiment of the present disclosure.

### DESCRIPTION OF EXAMPLE EMBODIMENTS

### Overview of Example Embodiments

Modern data center and high-performance computing environments face significant challenges in managing heterogeneous computing infrastructures that incorporate specialized processing units such as data processing units (DPUs) alongside traditional host processors. Existing infrastructure management systems were primarily designed for homogeneous computing environments and lack the capability to effectively coordinate the lifecycles of different types of processing units. This creates operational complexity when deploying and managing infrastructure services across distributed computing environments, particularly when these services need to be offloaded to specialized hardware components.

The provisioning and lifecycle management of DPUs presents unique challenges that are not adequately addressed by current solutions. Traditional provisioning approaches do not account for the interdependencies between host computers and their associated DPUs, leading to potential synchronization issues and operational inefficiencies. When DPUs require updates, configuration changes, or maintenance operations, the impact on the host computer's workload and operational state is often not properly managed, resulting in service disruptions and suboptimal resource utilization.

Service function chaining in heterogeneous computing environments introduces additional complexity, as network traffic must be efficiently processed through sequences of network functions or services deployed across different types of processing hardware. Current service chaining implementations typically do not leverage hardware acceleration capabilities available in modern DPUs, resulting in performance bottlenecks and inefficient resource utilization. The lack of integrated orchestration between service deployment and hardware-accelerated packet processing further compounds these performance limitations.

Container orchestration platforms, while effective for managing distributed applications, do not provide adequate support for managing specialized hardware components and their associated services. The extension of orchestration capabilities to coordinate between host processors and DPUs requires sophisticated lifecycle management that current platforms do not offer. This gap becomes particularly problematic in large-scale deployments where hundreds or thousands of DPUs must be managed in coordination with their respective host systems.

Embodiments of the present disclosure address at least some of the above drawbacks by providing at least one management node that provisions software on processing cores of each data processing unit (DPU) in a system including a plurality of DPUs and synchronizes the lifecycle of each DPU with the lifecycle of a respective host computer during software provisioning.

In some embodiments, the system provides comprehensive DPU provisioning and lifecycle management through a two-tier container orchestration platform architecture comprising a host cluster and at least one DPU cluster, where the DPU cluster is managed by the host cluster. This hierarchical approach enables centralized management of both host and DPU resources while maintaining the flexibility to scale DPU clusters automatically as the number of DPUs grows. The management node can provision operating systems and services on DPU processing cores through multiple pathways, including via management paths through host operating systems in trusted environments or via out-of-band management paths through baseboard management controllers (BMCs) in zero-trust environments.

In some cases, the system implements sophisticated lifecycle synchronization by applying node effects to host computers during DPU provisioning operations. These node effects may include draining workloads from the host computer, preventing new workloads from running, creating events for application reaction, or executing user-provided scripts. This synchronization ensures that DPU maintenance and updates do not disrupt host operations and that both components remain in coordinated operational states throughout their lifecycles.

In some embodiments, the system provides advanced service function chaining capabilities where the management node defines service function chaining between services installed on DPU processing cores, and the DPU processing cores implement the defined service function chaining. The system leverages hardware acceleration by having DPU processing cores process initial packets of network flows using chained services, analyze the processing results, and program packet processing pipeline hardware to handle subsequent packets of the same flow according to the analyzed results. This approach significantly improves performance by offloading repetitive packet processing operations to dedicated hardware while maintaining the flexibility of software-defined service chains.

### Definitions

As used herein, the term “management node” may refer to a computing component or system that provides centralized control and coordination for provisioning, configuring, and managing other computing resources in a distributed environment. For example, a management node may coordinate the deployment of operating systems and service software across multiple DPUs, or orchestrate service updates across a cluster of processing units, or manage service function chaining in the DPUs.

As used herein, the term “data processing unit (DPU)” may refer to a specialized processing device that combines networking and optionally other functions with programmable processing cores, typically designed to offload infrastructure tasks from host processors. For example, a DPU may handle packet processing for network traffic or execute containerized security services while connected to a host computer via PCIe interface.

As used herein, the term “host computer” may refer to a computing system that serves as the primary processing platform and is connected to one or more specialized processing units such as DPUs. For example, a host computer may run application workloads while its connected DPU handles networking and security functions, or a server that manages computational tasks while delegating infrastructure services to attached DPUs.

As used herein, the term “network interface controller (NIC)” may refer to a hardware component that provides network connectivity and packet processing capabilities, often integrated within a DPU or other processing device. For example, a NIC may include Ethernet ports for physical network connections and packet processing circuitry for handling network communications, or specialized hardware for accelerating network protocol processing.

As used herein, the term “processing cores” may refer to computational units within a processing device that execute software instructions and perform data processing operations. For example, processing cores in a DPU may run containerized services or execute packet processing algorithms, or ARM-based cores that handle control plane operations.

As used herein, the term “baseboard management controller (BMC)” may refer to a specialized microcontroller that provides out-of-band management capabilities for monitoring and controlling hardware components independently of the main operating system. For example, a BMC may enable remote provisioning of a DPU's operating system without requiring access through the host computer, or provide hardware monitoring and power management functions for system maintenance.

As used herein, the term “software” may refer to computer programs, applications, operating systems, and other executable code that runs on processing hardware to provide functionality and services. For example, software may include a DPU operating system that manages hardware resources and hosts containerized applications, or service applications that implement networking, security, or storage functions.

As used herein, the term “operating system” may refer to system software that manages hardware resources and provides a platform for running applications and services. For example, an operating system on a DPU may manage processing cores, memory, and network interfaces while hosting containerized services, or a Linux-based system that provides container runtime environments and hardware abstraction.

As used herein, the term “services” may refer to software applications or functions that provide specific capabilities or functionality within a computing system. For example, services may include networking functions that handle packet routing and filtering, or security services that perform encryption and access control operations.

As used herein, the term “containerized applications” may refer to software applications packaged with their dependencies and runtime environment in portable containers that can be deployed and managed consistently across different computing platforms. For example, containerized applications may include microservices deployed using container orchestration platforms like Kubernetes, or network functions packaged as Docker containers for deployment on DPU processing cores.

As used herein, the term “packet processing services” may refer to software functions that handle the processing, routing, filtering, or transformation of network packets as they traverse through a computing system. For example, packet processing services may include firewall functions that inspect and filter network traffic based on security policies, or load balancing services that distribute network traffic across multiple backend servers.

As used herein, the term “DPU management services” may refer to software functions that monitor, configure, and control the operation of data processing units and their associated resources. For example, DPU management services may include telemetry collection services that gather performance metrics and health status information, or configuration management services that apply policy updates and system settings to DPU components.

As used herein, the term “security services” may refer to software functions that provide protection, authentication, encryption, or access control capabilities within a computing system.

As used herein, the term “container orchestration platform” may refer to a system that automates the deployment, management, scaling, and coordination of containerized applications across clusters of computing nodes. For example, a container orchestration platform may provide APIs for deploying services across multiple DPUs and managing their lifecycles, or Kubernetes clusters that coordinate container scheduling and resource allocation.

As used herein, the term “container orchestration platform API” may refer to the application programming interface that provides programmatic access to container orchestration platform functionality for deploying and managing containerized applications. For example, a container orchestration platform API may enable automated deployment of services to DPU clusters through REST API calls, or Kubernetes API endpoints that allow creation and management of pods, services, and other resources.

As used herein, the term “two-tier container orchestration platform architecture” may refer to a hierarchical system design where one container orchestration platform manages and coordinates multiple subordinate container orchestration platforms. For example, a two-tier architecture may include a host cluster that manages multiple DPU clusters, with the host cluster providing centralized control while DPU clusters handle local service deployment and management.

As used herein, the term “host cluster” may refer to a container orchestration cluster that manages host computers and provides centralized control for coordinating with associated DPU clusters. For example, a host cluster may run management controllers that provision operating systems on connected DPUs, or orchestrate service deployments across both host and DPU resources in a coordinated manner. The “host cluster” may be known as a “management cluster”, for example, when the host cluster does not manage host computers in zero-trust environments.

As used herein, the term “DPU cluster” may refer to a container orchestration cluster composed of data processing units that provides a platform for deploying and managing services on DPU processing cores. For example, a DPU cluster may manage containerized networking services deployed across multiple DPUs, or provide a Kubernetes environment where DPUs serve as worker nodes for service execution.

As used herein, the term “lifecycle” may refer to the complete sequence of states and transitions that a computing component or system experiences from initial deployment through operational use to eventual decommissioning. For example, a DPU lifecycle may include provisioning, configuration, service deployment, maintenance, and retirement phases, or the operational states of a host computer from boot-up through normal operation to shutdown.

As used herein, the term “lifecycle synchronization” may refer to the coordination of state changes and operational phases between related computing components to ensure consistent and compatible operation. For example, lifecycle synchronization may involve coordinating DPU maintenance operations with host workload scheduling to prevent service disruptions, or ensuring that DPU and host system updates are applied in a coordinated manner.

As used herein, the term “provisioning” may refer to the process of preparing, configuring, and deploying computing resources, software, or services to make them ready for operational use. For example, provisioning may include installing an operating system on DPU processing cores and configuring network interfaces, or deploying containerized services to a DPU cluster with appropriate resource allocations and network connectivity.

As used herein, the term “management path” may refer to a communication channel or route through which management operations and control commands are transmitted between management systems and target devices. For example, a management path may route DPU provisioning commands through the host computer's operating system and network stack, or provide connectivity for deploying software updates from management nodes to DPU processing cores.

As used herein, the term “out-of-band management path” may refer to a dedicated communication channel that operates independently of the main data network or host system, typically used for system management and control operations. For example, an out-of-band management path may enable direct communication with a DPU's baseboard management controller without relying on the host computer's network connectivity, or provide emergency access for system recovery and maintenance operations.

As used herein, the term “interface” may refer to a connection point, communication mechanism, or boundary between different computing components, systems, or software layers that enables interaction and data exchange. For example, an interface may provide connectivity between management nodes and DPU clusters for service orchestration, or define the API endpoints through which applications interact with container orchestration platforms.

As used herein, the term “packet processing pipeline hardware” may refer to specialized hardware components designed to efficiently process network packets through a series of operations such as parsing, classification, modification, and forwarding. For example, packet processing pipeline hardware may include programmable packet processors that can be configured to implement custom forwarding rules and traffic policies, or hardware accelerators that offload repetitive packet processing tasks from software to improve performance.

As used herein, the term “network flow” may refer to a sequence of related network packets that share common characteristics such as source and destination addresses, protocols, and port numbers, typically representing a communication session between network endpoints. For example, a network flow may represent all packets in a Transmission Control Protocol (TCP) connection between a client and server, or a stream of User Datagram Protocol (UDP) packets carrying video data from a media source to multiple receivers.

As used herein, the term “packet” may refer to a formatted unit of data transmitted over a network that includes both payload data and control information such as headers containing address and protocol information. For example, a packet may be an Ethernet frame containing an Internet Protocol (IP) datagram with TCP segment data, or a network packet carrying application data along with routing and quality-of-service metadata.

As used herein, the term “subsequent packets” may refer to network packets that follow an initial packet within the same network flow and share similar characteristics that allow them to be processed using previously established rules or configurations. For example, subsequent packets in a TCP flow may be processed using hardware forwarding rules established after analyzing the first packet, or follow-on packets that can bypass software processing by leveraging cached forwarding decisions.

As used herein, the term “service function chaining” may refer to the ordered sequence of network service functions through which network traffic is processed, where each function performs specific operations.

As used herein, the term “chained services” may refer to network service functions that are connected in a sequential processing pipeline where the output of one service becomes the input to the next service in the chain. For example, chained services may include a sequence of security inspection, traffic shaping, and routing functions that process packets in order, or containerized network functions deployed on DPU processing cores that are interconnected to form a service processing pipeline.

As used herein, the term “defined service function chaining” may refer to a specific configuration or specification that establishes the order, connections, and processing rules for chaining network service functions together. For example, defined service function chaining may specify that incoming traffic should be processed through firewall, load balancer, and application proxy services in that sequence, or include configuration parameters that determine how packets are routed between different service functions.

As used herein, the term “node effects” may refer to operational changes or impacts applied to a computing node, typically a host computer, during maintenance, updates, or other management operations to ensure proper coordination with connected systems. For example, node effects may include draining workloads from a host computer before performing DPU maintenance operations, or applying scheduling restrictions to prevent new workloads from being assigned during system updates.

As used herein, the term “workloads” may refer to computational tasks, applications, or services that consume computing resources such as CPU, memory, and network bandwidth during their execution. For example, workloads may include machine learning training jobs running on host computers, or containerized applications deployed across a cluster of processing nodes that require specific resource allocations and performance guarantees.

As used herein, the term “draining workloads” may refer to the process of gracefully removing or relocating computational tasks from a computing node to prepare it for maintenance, updates, or other operations that require reduced system activity. For example, draining workloads may involve migrating running containers from a host computer to other nodes in the cluster before performing DPU firmware updates, or gradually reducing the number of active services on a node to minimize disruption during planned maintenance.

As used herein, the term “preventing workloads” may refer to the action of blocking or restricting new computational tasks from being scheduled or deployed on a computing node, typically during maintenance operations or system updates. For example, preventing workloads may involve marking a host computer as unavailable for new container deployments while DPU provisioning is in progress, or applying scheduling constraints that redirect new tasks to other available nodes in the cluster.

As used herein, the term “workload scheduling” may refer to the process of assigning computational tasks and applications to appropriate computing resources based on factors such as resource availability, performance requirements, and system policies. For example, workload scheduling may involve coordinating the placement of containers across both host computers and their associated DPUs to optimize resource utilization, or implementing policies that ensure critical applications receive priority access to processing resources.

As used herein, the term “event” may refer to a notification, signal, or occurrence that indicates a change in system state or the completion of a specific operation, typically used to trigger responsive actions in other system components. For example, an event may be generated when DPU provisioning completes successfully to notify host applications that infrastructure services are available, or system alerts that inform monitoring applications about resource utilization thresholds being exceeded.

As used herein, the term “user-provided script” may refer to custom executable code or commands supplied by system administrators or users to perform specific operations or configurations that are not covered by standard system functions. For example, a user-provided script may implement custom host preparation procedures before DPU maintenance operations, or automate specific configuration tasks that are unique to a particular deployment environment.

As used herein, the term “application” may refer to software programs or services that provide specific functionality or capabilities to users or other system components. For example, an application may be a web service running on a host computer that processes user requests, or a monitoring application that collects and analyzes system performance metrics from DPU clusters.

As used herein, the term “scaling” may refer to the process of adjusting the capacity, size, or number of computing resources to meet changing demand or performance requirements. For example, scaling may involve automatically creating additional DPU clusters when the number of managed DPUs exceeds cluster capacity limits, or dynamically adjusting the number of service instances based on traffic load patterns.

As used herein, the term “API” may refer to an application programming interface that defines the methods, protocols, and data formats for communication between different software components or systems. For example, an API may provide endpoints for deploying and managing containerized services on DPU clusters, or define the interface through which management nodes interact with container orchestration platforms.

As used herein, the term “user input” may refer to data, commands, or configuration parameters provided by system administrators, operators, or automated systems to specify desired system behavior or configuration. For example, user input may include service deployment specifications that define which containerized applications should be deployed on DPU clusters, or configuration parameters that specify network policies and traffic routing rules for service function chaining.

As used herein, the term “service ordering” may refer to the specification of the sequence or arrangement in which network service functions should process traffic within a service function chain. For example, service ordering may define that network packets should be processed first by a firewall service, then by a load balancer, and finally by an application proxy, or specify the priority and dependencies between different security and networking functions.

As used herein, the term “network policies” may refer to rules, configurations, or constraints that govern how network traffic is processed, routed, filtered, or managed within a computing system. For example, network policies may define access control rules that determine which traffic is allowed between different service functions, or quality-of-service policies that specify bandwidth allocation and priority handling for different types of network flows.

As used herein, the term “traffic routing” may refer to the process of directing network packets or data flows along specific paths through a network or service infrastructure based on routing rules, policies, or algorithms. For example, traffic routing may involve directing packets through a sequence of chained services based on packet headers and service function chain configuration, or implementing load balancing algorithms that distribute traffic across multiple service instances.

As used herein, the term “automatic scaling” may refer to the capability of a system to dynamically adjust its capacity or resources without manual intervention, typically in response to changing demand, performance metrics, or predefined thresholds. For example, automatic scaling may involve creating additional DPU clusters when the number of managed DPUs grows beyond current cluster capacity, or dynamically adjusting the number of service instances based on traffic load and performance requirements.

### System Description

Documents incorporated by reference herein are to be considered an integral part of the application except that, to the extent that any terms are defined in these incorporated documents in a manner that conflicts with definitions made explicitly or implicitly in the present specification, only the definitions in the present specification should be considered.

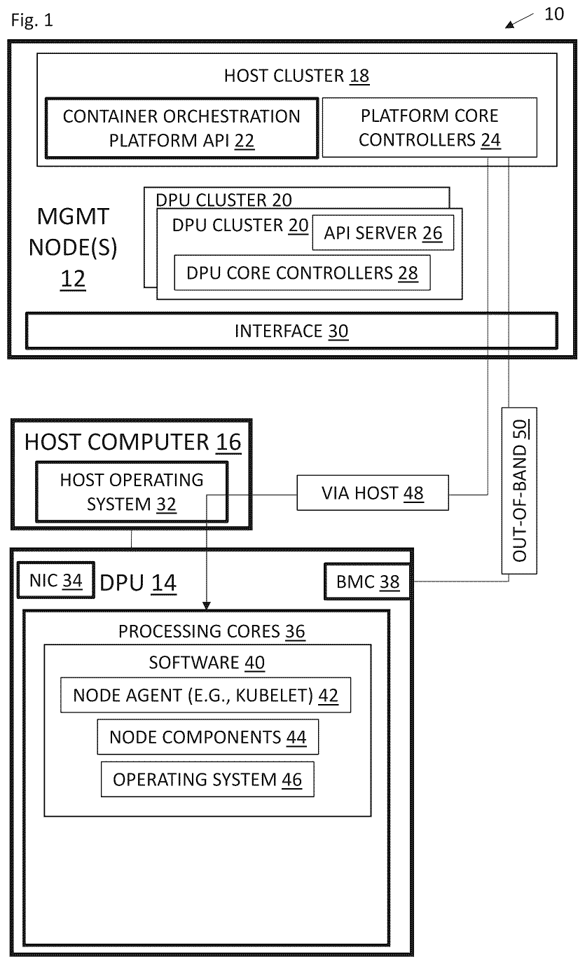

Reference is now made to FIG. 1, which is a block diagram illustrating a system 10 for provisioning and managing data processing units 14 in a distributed computing environment. The system 10 comprises a plurality of host computers 16, where each host computer 16 includes a processor (not shown) to execute a host operating system 32 that manages the local computing resources and applications. The system 10 further comprises data processing units 14, where each data processing unit 14 comprises a network interface such as a network interface controller 34 and processing cores 36. Each data processing unit 14 may be connected to a respective one of the host computers 16, e.g., forming paired computing units that operate in coordination with each other.

The system 10 includes at least one management node 12 that serves as the central control point for provisioning and orchestrating the distributed computing resources. The management node(s) 12 may be configured to provision software 40 on the processing cores 36 of each data processing unit 14, where the software 40 may include an operating system and/or one or more services. The management node 12 may be further configured to synchronize a lifecycle of each data processing unit 14 with a lifecycle of the respective host computer 16 during the provisioning of the software 40. This lifecycle synchronization ensures that both the data processing unit 14 and the host computer 16 operate in coordinated states during software deployment, updates, and maintenance operations. The management node 12 may implement a DOCA Platform Framework (DPF) as a software stack to allow provisioning and configuration of all DPU components including operating system, firmware, software, and DOCA services and/or any other suitable services.

The system 10 implements a two-tier container orchestration platform architecture comprising a host cluster 18 and at least one DPU cluster 20. The host cluster may be known as a management cluster, for example, when the “host cluster” does not manage the host computers 16. The host cluster 18 includes a container orchestration platform API 22 and platform core controllers 24 that manage the overall system orchestration and coordination functions. The container orchestration platform API 22 provides a programmatic interface for users and automated systems to interact with the provisioning and management capabilities of the system 10. The platform core controllers 24 implement the control logic for managing the lifecycle and coordination between host computers 16 and data processing units 14.

The management node(s) 12 may implement specific controllers such as DPUSet controller for managing groups of DPUs with common configurations, DPU controller for managing individual DPU lifecycle operations, BFB controller for managing BlueField Boot images and operating system provisioning, and DPUClusterAutoscaler controller for automatically scaling DPU clusters based on resource demand and capacity requirements.

Each DPU cluster 20 includes an API server 26 and DPU core controllers 28 that provide localized management and control functions for the data processing units 14 within that cluster. The API server 26 serves as the primary interface for receiving and processing requests related to the data processing units 14 in the cluster. The DPU core controllers 28 implement the specific control logic for managing individual data processing units 14, including their provisioning, configuration, and operational state management. The DPU cluster(s) 20 may be managed by the host cluster 18, creating a hierarchical management structure that enables scalable operations across large numbers of data processing units 14. The management node(s) 12 may be configured to automatically scale and create additional DPU clusters 20 as a number of DPUs 14 grows, providing dynamic resource management capabilities.

An interface 30 of the management node(s) 12 provides connectivity between components of the system 10, enabling communication and coordination between the various elements. The interface 30 may connect to the plurality of host computers 16 and the plurality of data processing units 14, facilitating the management and control operations performed by the management node 12. The processing cores 36 of each data processing unit 14 run software 40, which includes a node agent 42 such as Kubelet, node components 44, and a DPU operating system 46. The node agent 42 provides local management capabilities and serves as the communication interface between the data processing unit 14 and the management systems. The node components 44 include various system-level services and utilities that support the operation of the data processing unit 14.

The node components 44 may include various system-level services and utilities that support the operation of the data processing unit 14. In some cases, the node components 44 may comprise container runtime engines such as containerd or CRI-O that manage the lifecycle of containerized applications running on the processing cores 36. The node components 44 may also include network plugins such as Container Network Interface (CNI) plugins that configure network connectivity for containers and manage virtual network interfaces within the data processing unit 14.

The system 10 supports two distinct provisioning paths for deploying software 40 to the data processing units 14, providing flexibility for different security and operational requirements. A connection 48 via the host computer 16 enables the management node 12 to provision the operating system on the processing cores 36 of each data processing unit 14 via a management path through the host operating system 32 of the respective host computer 16. This provisioning approach may be used in trusted host environments where the host computer 16 has appropriate access and security credentials to manage the connected data processing unit 14.

Alternatively, the system 10 provides an out-of-band interface 50 that enables the management node 12 to provision the operating system on the processing cores 36 of each data processing unit 14 via an out-of-band management path through a baseboard management controller 38 of each data processing unit 14 without relying on host operating system access. The baseboard management controller 38 provides independent management capabilities that operate separately from the main processing systems, enabling secure and isolated provisioning operations. This out-of-band provisioning approach may be used in zero-trust environments where the host computer 16 cannot be trusted with management access to the data processing unit 14, or where additional security isolation may be required.

The DPU provisioning process implemented by the management node 12 includes multiple detailed phases such as initializing, where the system establishes initial communication channels and validates connectivity to the target DPU 14; node effect application, where the management node 12 applies coordinated lifecycle management actions to the respective host computer 16 such as draining workloads or preventing new workload scheduling; preparing BlueField Boot (BFB), where the system downloads and validates the appropriate operating system image for the specific DPU hardware configuration; initializing interface, where network interfaces and communication pathways are established between the management node 12 and the DPU 14; configuring firmware parameters, where hardware-specific settings and operational parameters are applied to optimize DPU performance and compatibility; OS installing, where the prepared BFB image is deployed to the processing cores 36 and the DPU operating system 46 is installed and configured; waiting for host reboot, where the system monitors for successful completion of any required host computer 16 restart operations; host network configuration, where networking components on the host computer 16 are configured to support communication with the newly provisioned DPU 14; DPU cluster config, where the DPU 14 is registered with the appropriate DPU cluster 20 and configured to participate in container orchestration activities; and node effect removal, where previously applied node effects are reversed to restore normal operation of the host computer 16 and allow resumption of regular workload scheduling.

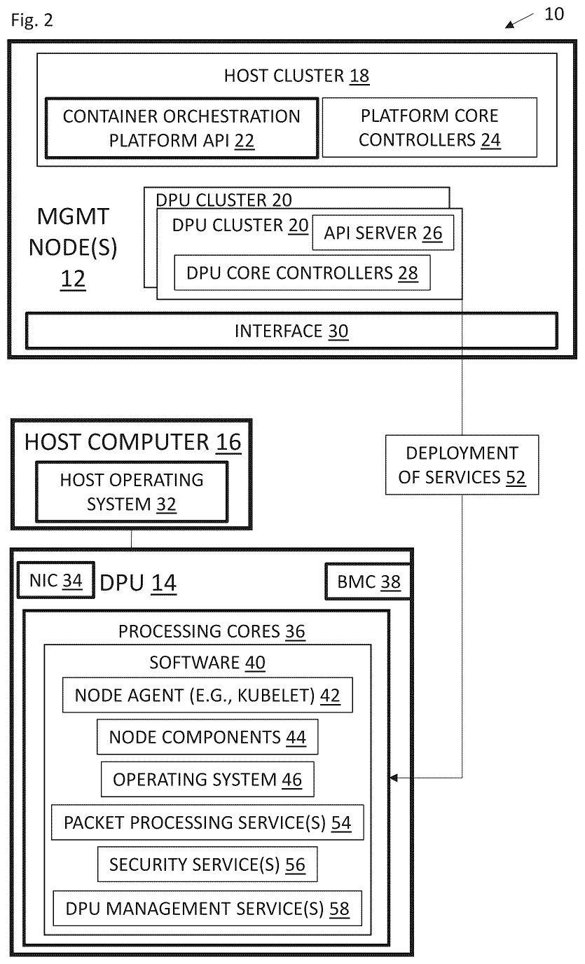

Reference is now made to FIG. 2, which is a block diagram of system 10 showing the service deployment capabilities. FIG. 2 illustrates the same components as FIG. 1 with additional service software installed on the processing cores 36 of each DPU 14. A block indicating service deployment 52 shows various services that may be deployed on the DPUs 14, demonstrating the comprehensive service provisioning capabilities of the system 10.

The block indicating service deployment 52 encompasses multiple categories of services that may be provisioned on the processing cores 36. In some cases, the software 40 comprises packet processing services 54, which are configured to handle network traffic processing operations on the DPUs 14. The packet processing services 54 may include various network functions such as load balancing, traffic shaping, and protocol processing that leverage the specialized capabilities of the network interface controller 34. These packet processing services 54 may be implemented as containerized applications that run within the DPU operating system 46 environment.

The system 10 also supports security services 56 as part of the software 40 deployment. The security services 56 may include firewall functionality, intrusion detection systems, and specialized security monitoring capabilities. In some cases, the security services 56 may comprise DOCA services such as security inspection services that analyze network traffic for threats and anomalies. The security services 56 may operate in conjunction with the packet processing services 54 to provide comprehensive network security functionality while maintaining high-performance packet processing capabilities.

Additionally, the system 10 includes DPU management services 58 that provide operational oversight and control of the DPU 14 components. The DPU management services 58 may include telemetry collection, performance monitoring, and configuration management functions. In some cases, the DPU management services 58 may comprise specific DOCA services such as DOCA HBN for routing operations, DOCA Firefly for time synchronization across the network infrastructure, DOCA Telemetry Service for comprehensive metrics collection and reporting, and SNAP for storage virtualization capabilities. These DPU management services 58 enable centralized monitoring and control of the DPU 14 operations while providing detailed insights into system performance and health.

The software 40 deployed on the processing cores 36 comprises containerized applications that provide flexibility and scalability in service deployment. The containerized applications may be packaged using standard container technologies and orchestrated through the container orchestration platform API 22. In some cases, the containerized applications enable rapid deployment, scaling, and management of services across multiple DPUs 14 in the system 10. The containerized nature of the applications allows for efficient resource utilization and isolation between different services running on the same DPU 14.

The management node(s) 12 may be configured to provision the software 40 on the processing cores 36 of each DPU 14 using a two-tier container orchestration platform architecture. This architecture comprises the host cluster 18 and DPU cluster(s) 20, where the DPU cluster(s) 20 may be managed by the host cluster 18. The two-tier architecture provides hierarchical management capabilities that separate the control plane operations in the host cluster 18 from the data plane operations in the DPU cluster(s) 20. The host cluster 18 deploys operating systems to the processing cores 36, while the DPU cluster(s) 20 deploy services and service chaining functionality. In some cases, this separation enables more efficient resource allocation and service orchestration across the distributed system 10.

The management node 12 is configured to automatically scale and create additional DPU clusters 20 as the number of DPUs 14 in the plurality of DPUs grows. This automatic scaling capability ensures that the system 10 may accommodate increasing workloads and expanding infrastructure without manual intervention. The scaling operations may be based on various metrics such as resource utilization, service demand, or predetermined capacity thresholds. In some cases, the automatic scaling functionality maintains optimal performance levels while efficiently utilizing available resources across the expanded DPU infrastructure.

The container orchestration platform API 22 provides the interface through which the management node 12 provisions and orchestrates services on each DPU 14. The container orchestration platform API 22 enables programmatic control over service deployment, configuration, and lifecycle management operations, allowing integration with different platforms. The API 22 may handle requests for service deployment, scaling operations, and configuration updates across the distributed DPU infrastructure, ensuring consistent and coordinated management of the containerized applications running on the processing cores 36.

The lifecycle synchronization between data processing units and host computers represents a coordinated approach to managing the operational states of interconnected computing resources during software provisioning operations. In some cases, the management node(s) may coordinate workload scheduling between each data processing unit and the respective host computer to maintain system stability and resource availability. This coordination may involve monitoring the operational status of both the data processing unit and the host computer, ensuring that provisioning activities do not interfere with important workloads or system operations. The synchronization process may include establishing communication channels between the management node(s) and both the data processing unit and host computer to exchange status information and coordinate timing of various provisioning phases.

Node effects may be applied to the respective host computer during provisioning of software on each data processing unit to manage the impact of provisioning operations on the host system. These node effects may serve as protective mechanisms that prepare the host computer for maintenance activities while minimizing disruption to running applications and services. In some cases, the application of node effects may be triggered automatically based on the type of provisioning operation being performed, or may be configured by system administrators based on specific operational requirements. The selection and timing of node effects may be determined by factors such as the criticality of running workloads, the expected duration of the provisioning operation, and the dependencies between the data processing unit and host computer.

Draining workloads from the respective host computer may involve systematically migrating or terminating running applications and services to prepare the host for maintenance activities. This draining process may include identifying active workloads, determining migration targets for stateful applications, and coordinating the orderly shutdown of services that cannot be migrated. In some cases, the draining process may involve communication with container orchestration platforms or workload schedulers to facilitate the migration of containerized applications to other available hosts. The draining operation may be performed gradually to minimize service disruption, with the management node(s) monitoring the progress and ensuring that all workloads have been successfully relocated or terminated before proceeding with data processing unit provisioning activities or the lifecycle of services on the DPU such as upgrading of operating system software or services.

Preventing workloads from running on the respective host computer may be implemented through various mechanisms that block new workload scheduling while allowing existing workloads to continue operation. This prevention mechanism may involve modifying scheduling policies, updating resource availability indicators, or applying scheduling constraints that direct new workloads to alternative hosts. In some cases, the prevention of new workloads may be combined with gradual draining of existing workloads to achieve a controlled transition to a maintenance state. The management node may coordinate with workload schedulers and orchestration platforms to ensure that the host computer is marked as unavailable for new workload placement while maintaining visibility into the current operational state.

Creating an event for reaction by an application running on the respective host computer may provide a notification mechanism that allows applications to respond appropriately to impending provisioning activities. These events may be generated through various communication channels, including system event buses, application programming interfaces, or direct inter-process communication mechanisms. In some cases, applications may register event handlers or callback functions that are invoked when provisioning events are generated, allowing the applications to perform cleanup operations, save state information, or initiate graceful shutdown procedures. The event creation mechanism may include metadata about the provisioning operation, such as the expected duration, the type of maintenance being performed, and any specific actions that applications should take in response to the event.

Running a user-provided script on the respective host computer may offer a flexible mechanism for implementing custom node effects that are tailored to specific operational environments or application requirements. These user-provided scripts may be executed with appropriate privileges to perform system-level operations such as service management, configuration updates, or custom notification procedures. In some cases, the scripts may be provided through configuration management systems, stored in centralized repositories, or embedded within provisioning templates that define the complete provisioning workflow. The management node may validate script syntax and permissions before execution, and may provide logging and monitoring capabilities to track script execution and capture any errors or status information generated during script operation.

The coordination of lifecycle synchronization may involve multiple phases of communication and state management between the management node(s), data processing unit, and host computer. During the initial phase, the management node(s) may assess the current state of both systems and determine the appropriate sequence of node effects to apply. The management node(s) may then initiate the selected node effects and monitor their completion before proceeding with data processing unit provisioning activities. Throughout the provisioning process, the management node(s) may continue to monitor the status of both systems and may adjust the synchronization approach based on changing conditions or unexpected events. Upon completion of provisioning activities, the management node(s) may reverse the applied node effects, allowing the host computer to resume normal operation and accept new workloads as appropriate.

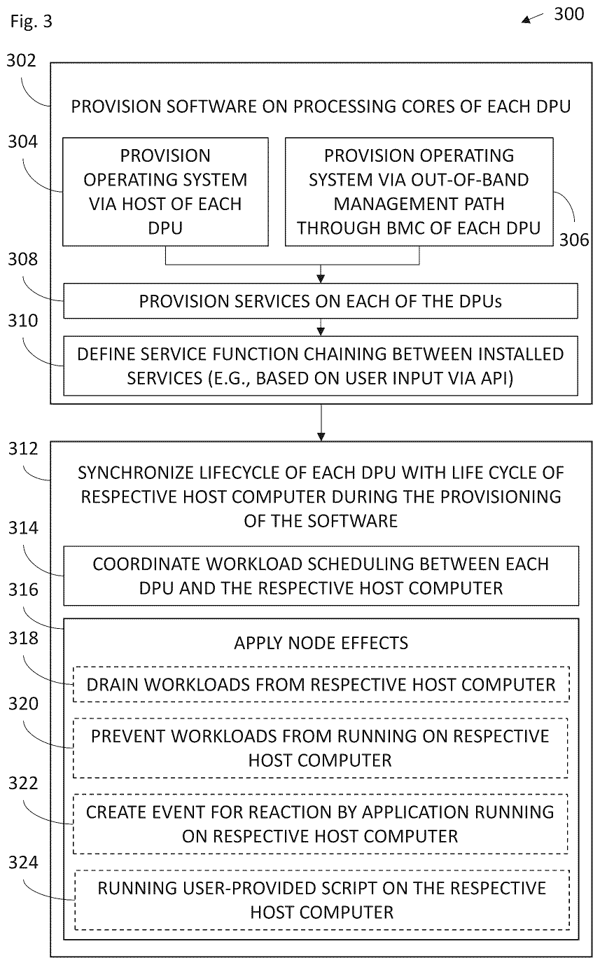

Reference is now made to FIG. 3, which is a flowchart illustrating a method 300 for provisioning software on processing cores 36 of data processing units 14. The method 300 provides a comprehensive approach to DPU provisioning that encompasses operating system installation, service deployment, and lifecycle synchronization between DPUs 14 and their respective host computers 16. The method 300 may be executed by management node(s) 12 to coordinate the provisioning process across multiple DPUs 14 in system 10.

The method 300 begins at a step 302 to provision software 40 on processing cores 36 of each DPU 14. The step 302 encompasses multiple provisioning operations that may be performed in sequence or in parallel depending on the specific requirements of the deployment. Within the step 302, the method 300 provides two alternative provisioning paths for operating system installation, allowing flexibility in deployment scenarios based on security requirements and infrastructure constraints. A substep 304 provisions an operating system via the respective host 16 of each DPU 14, representing a trusted host environment approach where the management node(s) 12 may utilize the host operating system 32 of the respective host computer 16 to install the DPU operating system 46. In some cases, the substep 304 may involve the management node(s) 12 communicating with a host service running on the host computer 16, which provides gRPC (Remote Procedure Call) interfaces for DPU provisioning operations. The substep 304 may include initializing communication with the host service, verifying DPU connectivity through the host computer 16, and transferring operating system images through the host-based management path.

Alternatively, a substep 306 provisions an operating system via out-of-band management path through BMC 38 of each DPU 14. The substep 306 represents a zero-trust environment approach where the management node(s) 12 bypass the host operating system 32 and communicate directly with the baseboard management controller 38 of each DPU 14. In some cases, the substep 306 may utilize Redfish APIs to manage the DPU 14 through the BMC 38, with all traffic flowing over the out-of-band network interface 50. The substep 306 may include establishing mTLS connections with the BMC 38, enabling rshim functionality on the BMC 38, and transferring operating system images directly to the DPU 14 without relying on host computer 16 access. The substep 306 may further include verifying BMC 38 connectivity, configuring BMC 38 certificates for secure communication, and monitoring the operating system installation progress through BMC 38 status reporting.

Following operating system provisioning, a substep 308 provisions services on each of the DPUs 14. The substep 308 may involve deploying containerized applications including packet processing services 54, security services 56, and DPU management services 58 onto the processing cores 36 of each DPU 14. In some cases, the substep 308 utilizes the two-tier container orchestration platform architecture where the host cluster 18 manages the deployment of services to the DPU cluster 20. The substep 308 may include creating service containers, configuring service networking, allocating computational resources on the processing cores 36, and establishing communication channels between services. The substep 308 may further involve configuring service-specific parameters, setting up service monitoring and logging, and validating service functionality after deployment.

A substep 310 defines service function chaining between installed services based on user input via an API. The substep 310 may involve the management node(s) 12 receiving user specifications for service ordering within chains and configuration of network policies for traffic routing between services in the chains. In some cases, the substep 310 creates service chain definitions that specify how packets should flow through multiple services deployed on the processing cores 36. The substep 310 may include parsing user-provided chain specifications, validating service compatibility within chains, and generating configuration data for implementing the defined service function chaining on the DPU 14.

The method 300 proceeds to a step 312 to synchronize lifecycle of each DPU 14 with lifecycle of respective host computer 16 during the provisioning of the software 40. The step 312 may take place in and around other steps such as steps 302-310. The step 312 ensures that the provisioning operations on the DPU 14 are coordinated with the operational state of the host computer 16 to prevent conflicts and maintain system stability. The step 312 encompasses multiple synchronization mechanisms that may be applied individually or in combination depending on the specific deployment requirements and infrastructure policies.

Within the step 312, a substep 314 coordinates workload scheduling between each DPU 14 and the respective host computer 16.

The substep 314 may involve the management node(s) 12 communicating with both the host cluster 18 and the DPU cluster 20 to ensure that workload assignments are properly balanced during operating system and service provisioning operations. In some cases, the substep 314 monitors the provisioning status of the DPU 14 operating system and services, and adjusts workload scheduling on the host computer 16 to prevent interference with the provisioning process. The substep 314 may include querying provisioning status from both the host computer 16 and the DPU 14, calculating optimal workload distribution that accommodates ongoing software provisioning activities, and implementing scheduling decisions that ensure host workloads do not conflict with DPU operating system installation or service deployment operations, and vice-versa that deployment operations do not interfere with workload processing.

A substep 316 applies node effects to manage the impact of DPU provisioning, service provisioning, and lifecycle management on the host computer 16. The substep 316 may include multiple types of node effects that can be applied individually or in combination to ensure proper coordination between the DPU 14 and host computer 16 during provisioning operations. The substep 316 encompasses several specific node effect operations that provide different levels of impact on the host computer 16 operation.

A substep 318 drains workloads from respective host computer 16. The substep 318 may involve the management node(s) 12 instructing the host computer 16 to gracefully terminate or migrate existing workloads before beginning DPU provisioning operations. In some cases, the substep 318 creates a NodeMaintenance custom resource that triggers the workload draining process and monitors the completion of workload evacuation. The substep 318 may include identifying active workloads on the host computer 16, initiating graceful shutdown procedures, and verifying that all workloads have been successfully drained before proceeding with DPU provisioning.

A substep 320 prevents workloads from running on respective host computer 16. The substep 320 may involve applying taints or other scheduling restrictions to the host computer 16 to prevent new workloads from being scheduled during DPU provisioning operations. In some cases, the substep 320 modifies the scheduling metadata of the host computer 16 to indicate that the host computer 16 is undergoing maintenance and should not receive new workload assignments. In a Kubernetes environment, the substep 320 may include updating host computer 16 labels, applying scheduling taints, and configuring admission controllers to reject new workload requests for the affected host computer 16. In non-Kubernetes environments, equivalent substeps may be performed.

A substep 322 creates event for reaction by application running on respective host computer 16. The substep 322 may involve the management node(s) 12 generating notification events that can be consumed by applications or monitoring systems running on the host computer 16. In some cases, the substep 322 publishes events to a message queue or event bus that applications can subscribe to for receiving notifications about DPU provisioning status. The substep 322 may include formatting event messages with relevant provisioning information, publishing events to configured event channels, and maintaining event delivery confirmation mechanisms.

A substep 324 involves running user-provided script on the respective host computer 16. The substep 324 may allow users to define custom logic for handling the coordination between DPU provisioning and host computer 16 operations. In some cases, the substep 324 retrieves user-provided scripts from configuration storage and executes the scripts on the host computer 16 with appropriate permissions and security constraints. The substep 324 may include validating script syntax and security, transferring scripts to the host computer 16, executing scripts with proper isolation, and collecting script execution results for monitoring and debugging purposes.

Following successful deployment of the operating system or services, the method 300 may perform several post-deployment operations to ensure system readiness and operational continuity. The management node(s) 12 may verify the successful completion of the provisioning process by conducting health checks on the newly deployed DPU operating system 46 and services. These verification steps may include confirming that the DPU operating system 46 has booted successfully, validating that all required system services are running, and ensuring that the processing cores 36 are responsive to management commands.

The management node(s) 12 may perform service validation operations to confirm that the deployed services are functioning correctly within their intended operational parameters. In some cases, this validation may involve executing service-specific health checks, verifying network connectivity between services, and confirming that service function chaining configurations have been properly applied. The management node(s) 12 may also validate that containerized applications are running with appropriate resource allocations and that inter-service communication pathways are operational.

Upon successful validation of the DPU provisioning, the management node(s) 12 may initiate the reversal of previously applied node effects to restore normal operation of the host computer 16. This restoration process may include removing scheduling taints that were applied during substep 320, allowing the host computer 16 to accept new workload assignments. The management node(s) 12 may also terminate any NodeMaintenance custom resources that were created during substep 318, signaling that the host computer 16 is available for normal workload scheduling.

The management node(s) 12 may update the operational status of both the DPU 14 and the host computer 16 in the container orchestration platform to reflect their current availability and readiness states. In some cases, this may involve updating custom resource definitions to indicate successful provisioning completion and marking both the DPU 14 and host computer 16 as available for production workloads. The management node(s) 12 may also register the newly provisioned DPU 14 with the appropriate DPU cluster 20, enabling it to participate in service orchestration and workload distribution.

The management node(s) 12 may perform post-deployment monitoring initialization to establish ongoing oversight of the provisioned DPU 14 and its services. This monitoring setup may include configuring telemetry collection from the DPU management services 58, establishing log aggregation for deployed services, and setting up alerting mechanisms for operational anomalies. The management node(s) 12 may also initiate performance baseline collection to establish normal operational metrics for future comparison and optimization activities.

In some cases, the management node(s) 12 may execute post-deployment configuration tasks that were deferred until after successful provisioning completion. These tasks may include applying environment-specific network policies, configuring service-to-service authentication mechanisms, and establishing integration points with external monitoring and management systems. The management node(s) 12 may also perform any required service registration activities to make the newly deployed services discoverable within the broader infrastructure ecosystem.

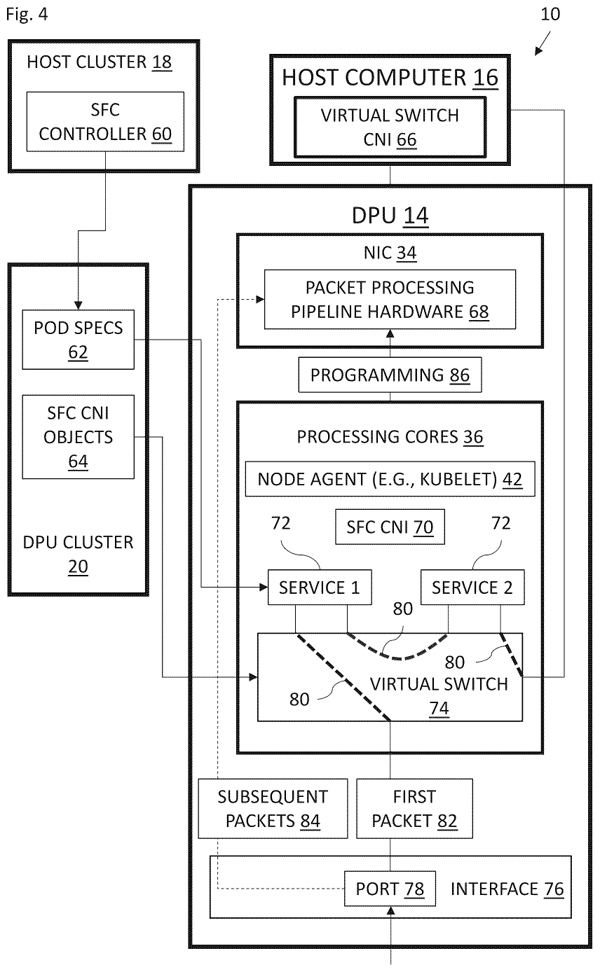

Reference is now made to FIG. 4, which is a block diagram illustrating the service function chaining implementation within system 10.

The system 10 includes host cluster 18 containing a Service Function Chaining (SFC) controller 60, and host computer 16 containing a virtual switch Container Network Interface (CNI) 66 (e.g., Open vSwitch CNI). Data processing unit 14 includes network interface controller 34 and processing cores 36, with processing cores 36 executing node agent 42. The data processing unit 14 may be associated with Data Processing Unit (DPU) cluster 20 that contains pod specifications 62 and Service Function Chaining (SFC) Container Network Interface (CNI) objects 64.

The data processing unit 14 includes packet processing pipeline hardware 68 within network interface controller 34. The data processing unit 14 also includes an SFC CNI 70 and service instances 72 (also known as pods). The service instances 72 have connections that connect to a virtual switch 74 (e.g., Open vSwitch). The connections of service instances 72 may be chained using service chains 80. The virtual switch 74 connects to an interface 76 that includes one or more ports 78.

The service function chaining may be implemented using SFC CNI 70 that extends virtual switch CNI capabilities. The SFC CNI 70 may be configured to manage the creation and configuration of service chains 80 between service instances 72. In some cases, the SFC CNI 70 coordinates with virtual switch CNI 66 on host computer 16 to establish connectivity between host-based services and DPU-based services. The SFC controller 60 may be configured to orchestrate the overall service function chaining process by managing the deployment and configuration of service instances 72 across the data processing units 14.

The system 10 may use Open vSwitch for implementing service chains 80 and traffic steering, with virtual switch 74 providing connectivity between physical ports, service interfaces, and host interfaces. The virtual switch 74 may be configured to establish logical connections between service instances 72 according to the defined service chains 80. In some cases, the virtual switch 74 creates multiple virtual topologies that interconnect different service instances 72, allowing packets to flow through the chained services in a predetermined order. The interface 76 and ports 78 may provide the physical connectivity points where packets enter and exit the service chain processing.

As further shown in FIG. 4, the system 10 processes a first packet 82 using the chained service instances 72 and analyzes the processing of first packet 82 to yield programming data 86. The programming data 86 may be used to configure packet processing pipeline hardware 68 to process subsequent packets 84. The processing cores 36 may be configured to analyze packet modifications through service chains 80 and create a consolidated flow rule or mega flow that can be programmed into packet processing pipeline hardware 68 for subsequent packets 84. In some cases, this analysis involves examining how first packet 82 was modified by each service instance 72 in service chains 80, determining the overall transformation applied to first packet 82, and generating programming data 86 that encapsulates these transformations. In some cases, each service instance 72 determines the transformation applied to the first packet 82 and generates programming data that encapsulates the transformation, and each service 72 programs the packet processing pipeline hardware 68 for subsequent packets 84.

The service function chaining may support different traffic types and can route different packet types through different service chains 80 based on packet characteristics. The SFC controller 60 may be configured to define service function chaining between services installed on processing cores 36 of each data processing unit 14 based on user input via an API. The user input may specify service ordering within service chains 80 and configuration of network policies for traffic routing between service instances 72 in service chains 80. In some cases, the API allows users to specify complex chaining topologies where different types of packets follow different paths through service instances 72 based on packet headers, payload content, or other packet characteristics.

The processing cores 36 may be configured to implement the defined service function chaining by running service instances 72 and coordinating their interconnection through virtual switch 74. When processing cores 36 process first packet 82 of a network flow using the chained service instances 72, processing cores 36 may analyze a result of the processing of first packet 82 and program packet processing pipeline hardware 68 to process subsequent packets 84 of the network flow according to the analyzed result. This programming may involve installing flow rules, lookup tables, or other hardware configurations that enable packet processing pipeline hardware 68 to apply the same transformations to subsequent packets 84 without requiring them to traverse the full service chain path through service instances 72.

The node agent 42 manages the lifecycle of services on the DPU, communicates with the API server, and coordinates with the SFC CNI to set up networking for containerized services. The node agent 42 calls the SFC CNI when services need to be connected to service chains, and it ensures that the services are properly configured and running according to their specifications. The agent also handles service creation, deletion, and health monitoring on the DPU processing cores.

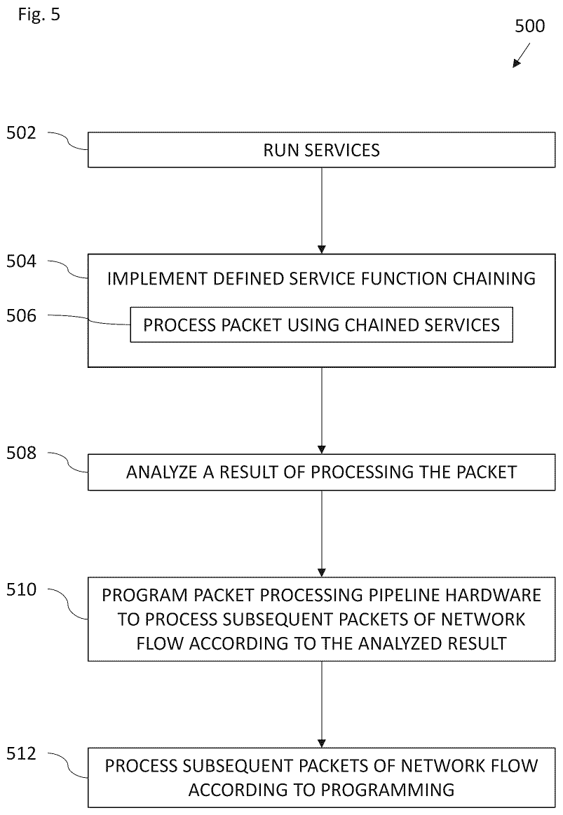

Reference is now made to FIG. 5, which is a flowchart illustrating a method 500 for running services and implementing service function chaining on data processing units. The method 500 provides a systematic approach for executing services, processing packets through chained services, analyzing processing results, and programming packet processing pipeline hardware for enhanced performance of subsequent packet processing operations. The processing results may be analyzed by each service individually or via the overall transformation applied to first packet 82 by the services as a whole.

The method 500 begins at a step 502 where the processing cores 36 of the data processing unit 14 are configured to run services. In some cases, the services may include packet processing services 54, security services 56, or DPU management services 58 as previously described. The processing cores 36 may execute these services as containerized applications within the DPU cluster 20 environment. The step 502 establishes the foundational service execution environment that enables the data processing unit 14 to perform various network functions and processing tasks. The services running on the processing cores 36 may be managed and orchestrated through the container orchestration platform API 22, which provides the necessary control and coordination mechanisms for service lifecycle management.

Following the initialization of services, the method 500 proceeds to a step 504 where the processing cores 36 are configured to implement defined service function chaining. The service function chaining may be defined by the management node 12 based on user input received through an API interface. In some cases, the service function chaining specifies the ordering of services within chains and configures network policies for traffic routing between services in the chains. The step 504 involves establishing the logical connections and data flow paths between different services running on the processing cores 36. The implementation of service function chaining may utilize the SFC CNI 70 and virtual switch 74 components to create the necessary network infrastructure for directing packets through the appropriate sequence of services.

The method 500 continues with a step 506 where the processing cores 36 are configured to process a packet using the chained services. During the step 506, a first packet 82 of a network flow may be directed through the established service chains 80, allowing each service in the chain to perform its designated processing function on the packet. The packet processing may involve various operations such as security inspection, traffic analysis, protocol processing, or data transformation depending on the specific services included in the chain. The step 506 represents the initial packet processing phase where the system processes packets through the complete service chain to understand the required processing operations and their effects on the packet data.

After processing the packet through the chained services, the method 500 advances to a step 508 where the processing cores 36 are configured to analyze a result or results of the processing of the packet. The analysis performed in the step 508 may involve examining the modifications made to the packet by each service in the chain, identifying the processing operations that were applied, and determining the overall transformation of the packet data. In some cases, each of the services determines the transformation applied to the packet data. In some cases, the analysis may include evaluating the packet headers, payload modifications, routing decisions, and any metadata generated during the processing. The step 508 enables the system to understand the complete processing workflow and create a consolidated view of the operations required for similar packets in the same network flow.

The method 500 then proceeds to a step 510 where the processing cores 36 are configured to program packet processing pipeline hardware of the data processing unit 14 to process subsequent packets of the network flow according to the analyzed result(s). The packet processing pipeline hardware 68 within the network interface controller 34 may be programmed with consolidated flow rules or mega flows that represent the combined processing operations identified during the analysis step. In some cases, each service may program the packet processing pipeline hardware 68 with rules for programming packets. For example, service 1 may program the packet processing pipeline hardware 68 with one or more rules, and service 2 may program packet processing pipeline hardware 68 with one or more rules. Therefore, subsequent packets may be processed by the rules programmed by service 1 and service 2. In some cases, the programming data 86 generated from the analysis may be used to configure hardware acceleration features that can perform the required processing operations directly in hardware without requiring software intervention. The step 510 enables the system to achieve enhanced performance by offloading repetitive processing operations to dedicated hardware components.

Finally, the method 500 concludes with a step 512 where the packet processing pipeline hardware 68 of the NIC 34 is configured to process subsequent packets of the network flow according to the programming applied to the packet processing pipeline hardware. During the step 512, subsequent packets 84 of the same network flow may be processed directly by the programmed packet processing pipeline hardware 68, bypassing the need for software-based processing through the service chains. This approach may provide enhanced throughput and reduced latency for packet processing operations. In some cases, the step 512 may involve monitoring the hardware processing results to ensure proper operation and may trigger reprogramming of the packet processing pipeline hardware 68 if network conditions or service requirements change. The method 500 may return to earlier steps if new packet flows are detected or if the service function chaining configuration is modified by the management node 12.

The system described herein may be implemented using various alternative embodiments and configurations that provide flexibility for different deployment scenarios and technical requirements. These alternative implementations allow the system to adapt to diverse infrastructure environments and operational needs while maintaining the core functionality of DPU provisioning and service orchestration.

In some cases, the container orchestration platform may utilize any suitable container orchestration system instead of Kubernetes for managing containerized services across the DPU clusters. Alternative virtualized cloud platforms may be employed to support the system architecture.

Different DPU hardware configurations may be supported beyond the BlueField architecture. Alternative DPU implementations may include different processing core architectures, such as RISC-V based processors or custom ASIC designs. The baseboard management controller functionality may be integrated into the main processing cores or implemented as separate microcontroller units depending on the specific hardware design.

Service chaining implementations may utilize alternative networking technologies beyond Open vSwitch. Vector Packet Processing (VPP) may serve as the underlying packet processing framework, providing high-performance packet forwarding capabilities.

Network topology variations may accommodate different data center architectures and connectivity requirements. Spine-leaf network topologies may influence the service function chaining implementation and traffic routing policies. Software-defined wide area network integration may extend service chains across multiple data center locations. Network function virtualization infrastructure may provide standardized interfaces for service chain integration with existing telecommunications equipment and protocols.

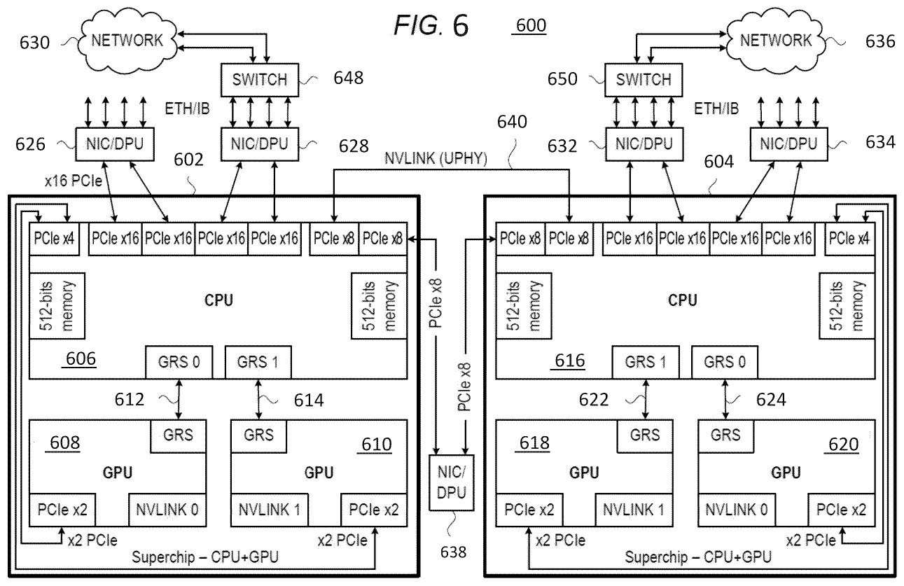

Reference is now made to FIG. 6, which is a block diagram that schematically illustrates a computing system 600, e.g., a data center or a High-Performance Computing (HPC) cluster, in accordance with an embodiment of the present disclosure.

System 600 comprises a plurality of subsystems, e.g., multiple processing devices coupled to each other, multiple network devices, and multiple networks, according to at least one embodiment. Computing system 600 is designed with multiple integrated circuits (referred to as processing devices), where each integrated circuit can include one or more CPUs and GPUs, forming a powerful and flexible architecture.

The various processing devices are interconnected via an NVLink or other high-speed interconnect, enabling high-speed communication between the subsystems, and are also connected through a NIC or DPU to ensure efficient data transfer across computing system 600 and to one or more external networks 630, 636. In the present example, system 600 comprises a packet switch 648 that connects NIC/DPU 628 to network 630, and a packet switch 650 that connects NIC/DPU 632 to network 636.

The coupling of processing devices through NVLink allows for seamless data exchange and parallel processing, enhancing overall computational performance. The processing devices are connected to multiple networks through one or more network interface cards (NICs) or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 600 can include one or more CPUs and one or more GPUs.

FIG. 6 also demonstrates an example architecture of a multi-GPU architecture. As illustrated in the figure, computing system 600 includes a processing device 602 with a multi-GPU architecture. In particular, processing device 602 may be a system-on-chip and includes multiple subsystems such as a CPU 606, a GPU 608, and a GPU 610. CPU 606 can be coupled to GPU 608 via a die-to-die (D2D) or chip-to-chip (C2C) interconnect 612, such as a Ground-Referenced Signaling interconnect (GRS interconnect). CPU 606 can be coupled to GPU 610 via a D2D or C2C interconnect 614. CPU 606 can also couple to GPU 608 and GPU 610 via PCIe interconnects.

CPU 606 can be coupled to one or more NICs or DPUs, which are coupled to one or more networks. For example, as illustrated in FIG. 6, CPU 606 is coupled to a first NIC/DPU 626, which is coupled to a network 630. CPU 606 is also coupled to a second NIC/DPU 628, which is coupled to network 630 via switch 648. NIC/DPU 626 and NIC/DPU 628 can be coupled to network 630 over Ethernet (ETH), NVLINK or InfiniBand (IB) connections, for example.

Computing system 600 also includes a processing device 604 with a multi-GPU architecture. In particular, processing device 604 includes multiple subsystems including a CPU 616, a GPU 618, and a GPU 620. CPU 616 can be coupled to GPU 618 via a D2D or C2C interconnect 622. CPU 616 can be coupled to GPU 620 via a D2D or C2C interconnect 624. CPU 616 can also couple to GPU 618 and GPU 620 via PCIe interconnects. CPU 616 can be coupled to one or more NICs or DPUs, which are coupled to one or more networks. For example, as illustrated in FIG. 6, CPU 616 is coupled to a first NIC/DPU 632, which is coupled to a network 636. CPU 616 is also coupled to a second NIC/DPU 634, which is coupled to network 636 via switch 650. NIC/DPU 632 and NIC/DPU 634 can be coupled to network 636 over Ethernet (ETH), NVLINK or InfiniBand (IB) connections.

In at least one embodiment, processing device 602 and processing device 604 can communicate with each other via a NIC/DPU 638, such as over PCIe interconnects. Processing device 602 and processing device 604 can also communicate with each other over a high-bandwidth communication interconnect 640, such as an NVLink interconnect or other high-speed interconnects. The packet switches in FIG. 6 may comprise, for example, Nvidia Quantum-2 switches. The NICs/DPUs in the figure may comprise, for example, Nvidia Bluefield DPUs.

The NIC of the DPU may include any of the following: an Ethernet Port (RJ45 Connector), which is the physical interface where the network cable (usually an Ethernet cable) connects to the NIC and is used for wired network connections; packet processing hardware or circuitry, which is responsible for handling network communication and processes incoming and outgoing data packets and manages the network interface functions; a memory (such as RAM or ROM) to store temporary data, such as network packet buffers, configuration settings, and firmware, and helps in speeding up data transfer and processing; firmware, which is software programmed into the NIC's memory and controls the hardware operations and may perform firmware updates to improve performance or add new features to the NIC; LED Indicators that provide visual indicators of network status, common indicators including power status, network activity, and link speed; a bus Interface (e.g., PCI or PCIe) to connect the NIC to the host computer's motherboard; a processor to handle network processing tasks as well as other processing tasks to offload work from the main CPU of the host device and improve network performance; a heat sink or cooling mechanism (e.g., for high-performance NICs), especially those used in servers, to prevent overheating; power management circuitry to ensure the NIC receives the correct amount of power and manages power consumption efficiently; and/or connector pins and circuitry including internal connections and pathways that route signals between the NIC's components.

The packet processing hardware or circuitry is the central component of the NIC and handles network communications. It may include several key components that work together to manage and process network data, such as any one or more of the following: MAC (Media Access Control) Layer, which is responsible for handling the data link layer of the OSI model and manages how data packets are formatted, addressed, and transmitted over the network; MAC address register, which stores the unique hardware address (MAC address) of the NIC; a frame buffer that temporarily holds data frames as they are being processed; a PHY (Physical Layer) Interface that interfaces with the physical medium (such as Ethernet cables) and is responsible for the actual transmission and reception of data bits over the network; a transceiver that converts data between the digital signals used by the MAC layer and the analog signals used for transmission over the network medium; DMA (Direct Memory Access) Controller that manages data transfers between the NIC and the computer's memory without involving the CPU and helps to offload processing tasks from the CPU and improve data transfer efficiency; a packet Processing Engine that handles the encapsulation and decapsulation of network packets, and processes incoming and outgoing packets, managing tasks like error checking and packet filtering; buffer management, which includes memory areas for storing packets temporarily, such as transmit buffers to store packets that are being sent from the computer to the network, receive buffers to store packets received from the network before they are processed by the system; an interrupt controller that manages and generates interrupts to notify the CPU of events such as packet reception or transmission completion and helps in efficient handling of network events; a clock generator, which provides timing signals for the various components of the NIC to synchronize their operations; a power management unit to regulate power consumption and manages power-saving features of the NIC chip to improve energy efficiency; error handling and correction logic, which detects and corrects errors in data transmission and reception, and may include features for error-checking protocols like CRC (Cyclic Redundancy Check); configuration registers that store configuration settings and parameters that control the NIC's operation, such as speed settings, interrupt configurations, and buffer sizes; firmware/ROM that contains the embedded software that controls the NIC's operations and manages network protocols.

In practice, some or all of these functions may be combined in a single physical component or, alternatively, implemented using multiple physical components. These physical components may comprise hard-wired or programmable devices, or a combination of the two. In some embodiments, at least some of the functions of the processing circuitry may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

The various elements described herein as performing particular tasks or steps may be configured to, adapted to, operative to, designed to, programmed to, or otherwise arranged to perform such tasks or steps. In some embodiments, these elements may include hardware components, software modules, firmware, or any combination thereof that enable the performance of the described functionality. The elements may be implemented using processing circuitry, dedicated hardware, programmable logic, or other suitable technologies that allow for the execution of the specified operations. Additionally, these elements may be selectively activated, controlled, or coordinated to perform their respective functions as part of the overall system operation.

The flowchart and block diagrams in the figures illustrate the architecture, functionality, and operation of possible implementations of systems, methods and computer program products according to various examples of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. The descriptions of the various examples of the present disclosure have been presented for purposes of illustration, but are not intended to be exhaustive or limited to the examples disclosed. Many modifications and variations will be apparent to those of ordinary skill in the art without departing from the scope and spirit of the described examples.

As used herein, the singular form “a”, “an” and “the” include plural references unless the context clearly dictates otherwise.

Various features of the disclosure which are, for clarity, described in the contexts of separate embodiments may also be provided in combination in a single embodiment. Conversely, various features of the disclosure which are, for brevity, described in the context of a single embodiment may also be provided separately or in any suitable sub-combination.

The embodiments described above are cited by way of example, and the present disclosure is not limited by what has been particularly shown and described hereinabove. Rather the scope of the disclosure includes both combinations and sub-combinations of the various features described hereinabove, as well as variations and modifications thereof which would occur to persons skilled in the art upon reading the foregoing description and which are not disclosed in the prior art.

What is claimed is:

1. A system, comprising:
a plurality of host computers;
a plurality of data processing units (DPUs), each DPU comprising a network interface controller (NIC) and processing cores, each DPU being connected to a respective one of the host computers; and
at least one management node to:
provision software on the processing cores of each DPU; and
synchronize a lifecycle of each DPU with a lifecycle of the respective host computer during the provisioning of the software.

2. The system according to claim 1, wherein the software comprises an operating system.

3. The system according to claim 2, wherein the at least one management node is to provision the operating system on the processing cores of each DPU via a management path through a host operating system of the respective host computer.

4. The system according to claim 2, wherein the at least one management node is to provision the operating system on the processing cores of each DPU via an out-of-band management path through a baseboard management controller (BMC) of each DPU without relying on host operating system access.

5. The system according to claim 2, wherein the software comprises any one or more of the following: packet processing services; DPU management services; or security services.

6. The system according to claim 5, wherein the software comprises containerized applications.

7. The system according to claim 1, wherein synchronizing the lifecycle of each DPU with the lifecycle of the respective host computer comprises applying node effects to the respective host computer during provisioning of the software on each DPU.

8. The system according to claim 7, wherein the node effects comprise at least one of: draining workloads from the respective host computer; preventing workloads from running on the respective host computer; creating an event for reaction by an application running on the respective host computer; or running a user-provided script on the respective host computer.

9. The system according to claim 1, wherein synchronizing the lifecycle of each DPU with the lifecycle of the respective host computer comprises coordinating workload scheduling between each DPU and the respective host computer.

10. The system according to claim 1, wherein the at least one management node is to provision the software on the processing cores of each DPU using a two-tier container orchestration platform architecture comprising a management cluster and at least one DPU cluster, wherein the at least one DPU cluster is managed by the management cluster.

11. The system according to claim 10, wherein the at least one management node is to automatically scale and create additional DPU clusters as a number of DPUs in the plurality of DPUs grows.

12. The system according to claim 1, wherein the at least one management node is to use a container orchestration platform API for provisioning and orchestrating services on each DPU.

13. The system according to claim 1, wherein:
the at least one management node is to define service function chaining between services installed on the processing cores of each DPU; and
the processing cores of each DPU are to implement the defined service function chaining.

14. The system according to claim 13, wherein the at least one management node is to define the service function chaining based on user input via an API, the user input specifying service ordering within the chains, and configuration of network policies for traffic routing between services in the chains.

15. The system according to claim 13, wherein the processing cores of one of the plurality of DPUs is to:
process a packet of a network flow using the chained services;
analyze at least one result of the processing of the packet; and
program packet processing pipeline hardware of the one DPU to process subsequent packets of the network flow according to the analyzed at least one result.

16. A management node system, comprising:
an interface to connect to a plurality of host computers and/or a plurality of data processing units (DPUs), each DPU being connected to a respective one of the plurality of host computers, each DPU comprising a network interface controller (NIC) and processing cores; and
at least one processor to:
provision software on the processing cores of each DPU; and
synchronize a lifecycle of each DPU with a lifecycle of the respective host computer during the provisioning of the software.

17. The management node system according to claim 16, wherein the software comprises an operating system.

18. The management node system according to claim 17, wherein the at least one processor is to provision the operating system on the processing cores of each DPU via a management path through a host operating system of the respective host computer.

19. The management node system according to claim 17, wherein the at least one processor is to provision the operating system on the processing cores of each DPU via an out-of-band management path through a baseboard management controller (BMC) of each DPU without relying on host operating system access.

20. The management node system according to claim 17, wherein the software comprises any one or more of the following: packet processing services; DPU management services; or security services.

21. The management node system according to claim 20, wherein the software comprises containerized applications.

22. The management node system according to claim 16, wherein synchronizing the lifecycle of each DPU with the lifecycle of the respective host computer comprises applying node effects to the respective host computer during provisioning of the software on each DPU.

23. The management node system according to claim 22, wherein the node effects comprise at least one of: draining workloads from the respective host computer; preventing workloads from running on the respective host computer; creating an event for reaction by an application running on the respective host computer; or running a user-provided script on the respective host computer.

24. The management node system according to claim 16, wherein synchronizing the lifecycle of each DPU with the lifecycle of the respective host computer comprises coordinating workload scheduling between each DPU and the respective host computer.

25. The management node system according to claim 16, wherein the at least one processor is to provision the software on the processing cores of each DPU using a two-tier container orchestration platform architecture comprising a management cluster and at least one DPU cluster, wherein the at least one DPU cluster is managed by the management cluster.

26. The management node system according to claim 25, wherein the at least one processor is to automatically scale and create additional DPU clusters as a number of DPUs in the plurality of DPUs grows.

27. The management node system according to claim 16, wherein the at least one processor is to use a container orchestration platform API for provisioning and orchestrating services on each DPU.

28. The management node system according to claim 16, wherein the at least one processor is to define service function chaining between services installed on the processing cores of each DPU based on user input via an API, the user input specifying service ordering within the chains, and configuration of network policies for traffic routing between services in the chains.

29. A data processing unit (DPU), comprising:
a network interface controller (NIC) including packet processing pipeline hardware; and
processing cores to:
run services; and
implement a defined service function chaining between respective ones of the services.

30. The DPU according to claim 29, wherein the processing cores are to:
process a packet of a network flow using the chained services;
analyze at least one result of the processing of the packet; and
program the packet processing pipeline hardware to process subsequent packets of the network flow according to the analyzed at least one result.
